(19) United States
(12) Patent Application Publication
(10) Pub. No.: US 2023/0322143 A1
(43) Pub. Date: Oct. 12, 2023

(54) Absorbent Cupholder Liner and Method for Manufactured Thereof

(71) Applicant: Ryan Curry, Arlington, TX (US)

(72) Inventor: Ryan Curry, Arlington, TX (US)

(21) Appl. No.: 17/716,702

(22) Filed: Apr. 8, 2022

(51) Int. Cl. B60N 3/10; B32B 25/06; B32B 37/12

(52) U.S. Cl. CPC B60N 3/10; B32B 25/06; B32B 2307/726; B32B 2307/7265; B32B 37/12

(57) ABSTRACT

An absorbent cupholder liner and method of manufacturing thereof for protecting a cupholder from spills and wear and tear. In a first embodiment, the cupholder liner is formed from an absorbent body including an absorbent layer and a barrier layer. The absorbent body can include a set of pull tabs. In a second embodiment, the cupholder liner is formed from two absorbent bodies connected by a perforated bridge and feature an absorbent layer and a barrier layer that may be adhered to each other. The cupholder liner can include a set of pull tabs. Placing the absorbent cupholder liner into the beverage holder slots of the cupholder engages the barrier layer of the cupholder liner with the bottom and side walls of the slots. Pull tabs on either side allow for easy gripping and relocation of the cupholder liner.

### BACKGROUND

### Technical Field

The present disclosure relates to a cupholder liner. More particularly, and not by way of limitation, the present disclosure is directed to an inexpensive, easily manufactured, disposable cupholder liner for absorbing spilled liquids and protecting the surface of a cupholder.

### Background

This background section is intended to provide a discussion of related aspects of the art that could be helpful to understanding the embodiments discussed in this disclosure. It is not intended that anything contained herein be an admission of what is or is not prior art, and accordingly, this section should be considered in that light.

Cupholders are ubiquitous devices designed to securely maintain cups or other forms of drink-containing vessels. Cupholders can be integrated into furniture, such as couches located in homes and seats located at entertainment venues. Cupholders are also commonly found dispersed throughout a vehicle, such as in the center console and/or along the interior doors. By virtue of the fact that cupholders are frequently utilized for securing liquid-filled vessels in moving vehicles or furniture subject to inadvertent movement, spillage is inevitable. Spilled beverages create sticky messes in the bottom of the cupholder that are often difficult to clean. Additionally, condensation on the exterior of the liquid-filled vessels can pool in the cupholder.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

A first embodiment of the present disclosure concerns a cupholder liner that includes at least one absorbing body formed from an absorbent layer and a barrier layer. When the cupholder liner includes two absorbing bodies, the cupholder liner includes a first absorbing body connected to a second absorbing body by a narrow bridge.

A second embodiment of the present disclosure concerns a method of manufacturing a cupholder liner. Steps of the method include applying a barrier layer to form a layered sheet and partitioning the layered sheet into a plurality of the cup holder liners. In a non-limiting embodiment, each of the plurality of cup holder liners includes a first absorbing body connected to a second absorbing body by a narrow bridge.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective view from the top of an embodiment of the absorbent cupholder liner according to an illustrative embodiment;

FIG. 2 is a perspective view from the bottom of an embodiment of the absorbent cupholder liner according to an illustrative embodiment;

FIG. 3 is a top view of an embodiment of the absorbent cupholder liner according to an illustrative embodiment;

FIG. 4 is a bottom view of an embodiment of the absorbent cupholder liner according to an illustrative embodiment;

FIG. 5 is a perspective environmental view of one or more absorbent cupholder liners housed a vehicle cupholder according to an illustrative embodiment;

FIG. 6 is a flowchart of a process for manufacturing an absorbent cupholder liner in accordance with an illustrative embodiment;

FIG. 7 is a flowchart of a particular process for applying a barrier layer to an absorbent liner according to an illustrative embodiment;

FIG. 8 is a cross section view from the side of an illustrative embodiment of the absorbent cupholder liner positioned above a vehicle cupholder, ready for insertion;

FIG. 9A is a cross section view from the front of an illustrative embodiment of the absorbent cupholder liner positioned above a vehicle cupholder, ready for insertion;

FIG. 9B is a cross section view from the front of an illustrative embodiment of the absorbent cupholder liner in the process of being inserted into a vehicle cupholder;

FIG. 9C is a cross section view from the front of an illustrative embodiment of the absorbent cupholder liner fully inserted into a vehicle cupholder;

FIG. 10 is a perspective environmental view of an illustrative embodiment of the absorbent cupholder liners positioned for insertion into a vehicle cupholder with a water bottle;

FIG. 11 is an environmental view from the top of an illustrative embodiment of the absorbent cupholder liner fully inserted into a vehicle cupholder; and

FIG. 12 is a perspective environmental view from the top of an illustrative embodiment of an absorbent cupholder liner in which the first absorbent body is detached from a second absorbent body and positioned above a single chamber cupholder, ready for insertion.

### DETAILED DESCRIPTION

While the novel cupholder liner can be used in numerous applications, such as in cupholders integrated into couches, chairs, recliners, and tables, the discussion of the cupholder liner herein will be limited to vehicular applications for the sake of consistency. In view of the foregoing, one type of conventional cupholder liner is a disc-shaped insert sized the bottom surface of a cupholder. While disc-shaped inserts can protect the bottom surface of the cupholder, they are ineffective against containing messes resulting from spilled liquids because the liquids inevitably end up trapped between the cupholder and the insert. The subsequent cleaning process requires removal of the insert and cleaning of not only the insert, but also the cupholder.

Another type of conventional cupholder liner is a cup-shaped insert that is sized to precisely fit inside a cupholder. The cup-shaped insert can contain messes, obviating the need to clean the cupholder. However, the cleaning process of the cup-shaped insert generally involves manually scrubbing the insert in much the same way that the cupholder would have been cleaned, or washing the insert in a dishwasher, which is easier but more time consuming. Novel aspects of the present disclosure provide for an improved cupholder liner that is inexpensive, disposable, and universally applicable to most cupholders. The improved cupholder liner is designed to absorb spilled liquids to help contain the resultant mess while preventing the absorbed liquid from penetrating through the entirety of the liner and to the cupholder below. Thus, the improved cupholder liner eliminates the burdensome and/or time-consuming cleaning process associated with conventional cupholder liners.

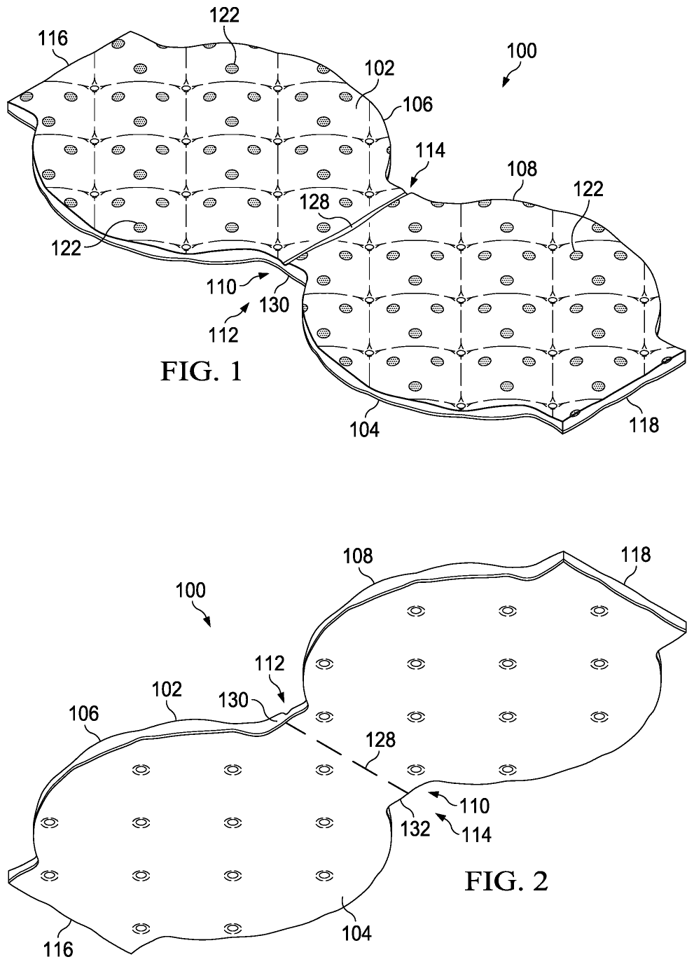

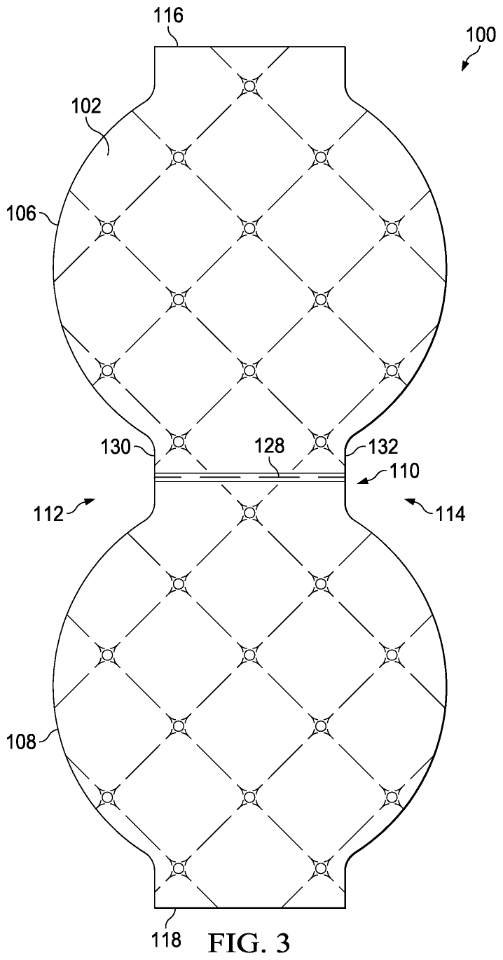

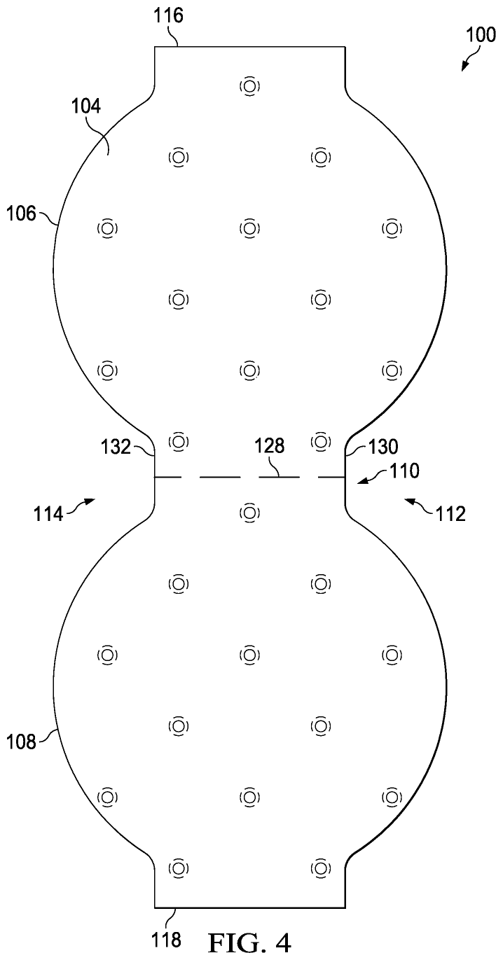

FIGS. 1-4 depict various perspective views of an absorbent cupholder liner according to an illustrative embodiment. The absorbent cupholder liner 100 is a generally planar insert formed from a plurality of overlapping layers. A first layer of the plurality of layers is the absorbent layer 102. The absorbent layer 102 is configured to absorb liquids and can be formed primarily from paper, cotton, a sponge type material or some combination thereof; however, any absorbing material known to one of ordinary skill in the art may suffice.

A second layer of the plurality of layers is a barrier layer 104, which is configured to prevent moisture trapped within the absorbent layer 102 from contacting a supporting surface, like the interior surface of a cupholder. The barrier layer 104 can be formed primarily from rubber, plastic, waterproof fabrics, polyurethane laminate, thermoplastic polyurethane, waxed cotton, nylon, polyester, vinyl, pleather, composite materials or any water resistant and waterproof material known to one of ordinary skill in the art. In the illustrative embodiment featured in FIGS. 1-4, the absorbent cupholder liner 100 is oriented such that the absorbent layer 102 is facing upward, whereas the barrier layer 104 is adjacent to the bottom of a cupholder, facing downward. By having the absorbent layer 102 facing upward, on top of the barrier layer 104, the effectiveness of the cupholder liner 100 absorbent capacity can be increased. However, the preferred orientation of the cupholder liner 100 is situational dependent. Alternate embodiments can feature the barrier layer 104 facing upward, on top of the absorbent layer 102 which, in turn, is adjacent to the bottom of the cupholder and facing downward. While the primary purpose of the absorbent layer 102 is to protect against spills, purposes of the barrier layer 104 is to help protect against solid debris such as crumbs. Note that the absorbent layer 102 also provides some protection against solid debris. The cup style shape of the illustrative embodiment of the absorbent cupholder liner 100 inserted into a cupholder assists with containment of said solid debris during removal of the liner from the cupholder.

The exemplary cupholder liner 100 depicted in FIGS. 1-4 are shown with only two layers, namely absorbent layer 102 and barrier layer 104. In a specific embodiment, the absorbent layer 102 is formed from a fibrous paper product and the barrier layer 104 is formed from vulcanized rubber. However, in other embodiments, the cupholder liner 100 can include additional layers. For example, the cupholder liner 100 can include two or more absorbent layers 102 formed from the same or different materials to increase absorbency or distribution of moisture once absorbed. In yet another embodiment, the cupholder liner 100 can include other layers on top, between, or below either of the depicted layers. For the two-layer illustrative embodiment in FIGS. 1-4 featuring one absorbent layer 102 and one barrier layer 104, the cupholder liner 100 will generally dry by the next day following a spill with no lingering signs of moisture. Alternate embodiments featuring more than one absorbent layer may take less time to dry, depending on the amount of spillage and the material used to manufacture the absorbent layer(s).

The exemplary cupholder liner 100 is generally formed from a first absorbing body 106 connected to a second absorbing body 108 by a narrow bridge 110 formed from a pair of opposing concavities 112 and 114. In addition, the first absorbing body 106 and the second absorbing body 108 are substantially circular. In some embodiments, the first absorbing body 106 and the second absorbing body 108 can include a pull tab extending outwardly to facilitate grasping and removal of the cupholder liner 100 from a cupholder. For example, cupholder liner 100 includes a first pull tab 116 extending outwardly from the first absorbing body 106 and a second pull tab 118 extending outwardly from the second absorbing body 108. In the depicted embodiment, the pull tabs 116 and 118 are generally rectangular but other shapes can be substituted.

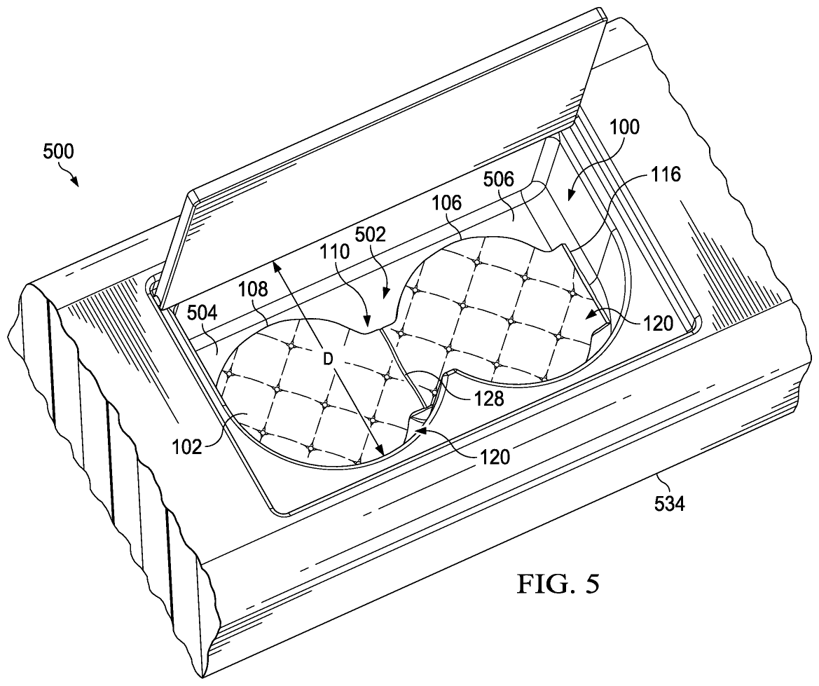

In one embodiment, the first absorbing body 106 and the second absorbing body 108 are dimensioned so that each can be received into a cupholder so that at least some of the periphery of each of the first absorbing body 106 and second absorbing body 108 folds upwardly. As a result, the effective lateral dimension D of the cupholder can be reduced, which can help to secure a cup within the cupholder 500. For example, when the cupholder liner 100 is inserted into a cupholder 500, the second absorbing body 108 is shown with a folded region 120 that can reduce the effective lateral dimension D. Once fully inserted, the absorbent cupholder liner 100 can then be readjusted such that both the pull tabs 116, 118 are easily accessible. It is also important to note that the illustrative embodiment of the absorbent cupholder liner 100 featured in FIG. 5 retains its shape even after it has come in contact with liquid after a spill and dried.

In other embodiments, one or both of the absorbing bodies 106, 108 are sized to fit inside the receiving chambers 504, 506 such that the sides of the receiving chambers are engaged but the lateral dimension D is not reduced as there is no need for the cupholder liner 100 to fold along the fold region 120 due to the snug fit of the absorbing bodies 106, 108 in the bottom of the receiving chambers 504, 506. In yet another embodiment, one or both of the absorbing bodies 106, 108 are sized to fit inside the receiving chambers 504, 506 such that none of the sides of the receiving chambers 504, 506 are engaged due to the fact that the circumference of the absorbing bodies 106, 108 is smaller than the circumference of the bottom of the receiving chambers 504, 506.

The concavities 112 and 114 that define the bridge 110 are dimensioned to allow the cupholder liner 100 to line the connecting void space 502 between the pair of receiving chambers 504 and 506 in cupholder 500. In the depicted embodiment, the bridge 110 is divided into two equal parts by a perforation 128, which allows the first absorbing body 106 to be separated from the second absorbing body 108. The illustrative embodiment featured in FIGS. 1-4 has each perforation arranged to form a line that traverses across the narrow bridge between the concavities 112, 114. The number of perforations is not limited to a specific number, and each perforation can but is not required to be equidistant from each adjacent perforation.

The separation of the cupholder liner 100 allows the cupholder liner 100 to be used in single chamber cupholders. Further, separation of the cupholder liner 100 along the perforation 128 results in the formation of two identically shaped pieces, each of which are bilaterally symmetrical. Because the pull tabs 116 and 118 are generally rectangular, the bridge 100 has a pair of opposing, parallel and linear edges 130 and 132, which result in the formation of pull tabs that are the same as pull tabs 116 and 118 upon separation along the perforation 128.

In some embodiments, the cupholder liner 100 can be scented so that the cupholder liner 100 can reduce messes from spilled liquids while also masking at least some of the unpleasant smells associated with vehicles, particularly older vehicles. In one embodiment, the cupholder liner 100 can include a scented layer on top of the absorbent layer 102, between the absorbent layer 102 and the barrier layer 104, or below the barrier layer. The scented layer can be formed from an absorbent material or from a non-absorbent material, like a plastic or polymeric substrate. In the event that scented layer is a non-absorbent material, the scented layer can include a plurality of apertures disposed throughout to permit liquids to pass through the scented layer. In this manner, application of the scented layer to the exposed surface of the absorbent layer 102 allows liquid to pass through the scented layer and to the absorbent layer 102 below. In another embodiment, the scent can be imparted to the cupholder liner 100 by application of a fragrant compound sprayed onto a surface or perimeter of the cupholder liner 100. With particular reference to FIG. 1, the cupholder liner 100 the fragrant compound 122 is sprayed onto the absorbent layer 102. The fragrant compound 122 is omitted from subsequent figures for the sake of simplicity.

FIG. 5 is a perspective environmental view of one or more absorbent cupholder liners 100 housed a vehicle cupholder 500 according to an illustrative embodiment The cupholder 500 may be located in the center console 534 of a vehicle. In the embodiment depicted in FIG. 5, the cupholder liner 100 is positioned with the absorbent layer 102 facing the opening of the cupholder 500, i.e., upwardly, and the barrier layer 104 facing downwardly. However, the cupholder liner 100 can be positioned with the barrier layer 104 facing upwardly with the absorbent layer 102 facing downwardly, if preferred.

The bridge 110 is situated between the first absorbing body 106 and the second absorbing body 108, which places the bridge 110 roughly in the middle of the cupholder 500, lining the void space 132 between the pair of receiving chambers 504, 506. In the embodiment featured in FIG. 5, the perforation along the bridge 110 has not been torn so the first absorbent body 106 and the second absorbent body 108 are still connected, allowing them to be moved and positioned as a single unit. The first pull tab 116 and the second pull tab 118 allow for quick removal of the absorbent cupholder liner 100 from the cupholder 500. By removing the absorbent cupholder liner 100, the base of the receiving chambers 504, 506 may be accessed for cleaning. The absorbent cupholder liner 100 can also be replaced because the absorbent cupholder liner 100 has become over saturated, unable to absorb anymore fluids.

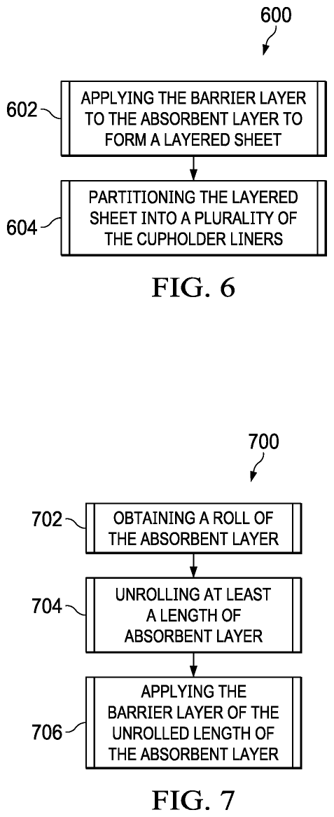

FIG. 6 is a flowchart of a process for manufacturing an absorbent cupholder liner in accordance with an illustrative embodiment. Each of the plurality of cupholder liners includes a first absorbing body connected to a second absorbing body by a narrow bridge.

Flowchart 600 begins at step 602 by applying the barrier layer to the absorbent layer to form a layered sheet.

In a non-limiting embodiment, where the barrier layer is a rubber-based layer, applying the barrier layer includes the additional steps of applying the rubber layer to the absorbent layer. The rubber layer can be applied to the absorbent layer by spraying a liquid rubber solution onto the absorbent layer. The rubber layer can be optionally cured to form a vulcanized rubber layer. In one or more embodiments, the rubber layer can be cured by exposure to an external source of heat.

In another non-limiting embodiment, the barrier layer can be applied to the absorbent layer by comprises adhering the barrier layer to the absorbent layer. Adhering can be achieved by conventional adhesives.

In step 604, the layered sheet is partitioned into a plurality of the cupholder liners. In a first embodiment, the layered sheet is partitioned by cutting the layered sheet with a cutting wheel rolled onto the layered sheet. In a second embodiment, the layered sheet is partitioned by cutting the layered sheet with a press plate pressed onto the layered sheet.

In yet another non-limiting embodiment, the partitioning of the layers sheet step 604 can further comprise perforating each of the plurality of cupholder liners along the narrow bridge.

FIG. 7 is a flowchart of a particular process for applying a barrier layer to an absorbent layer according to an illustrative embodiment. The process can be included in step 602 of FIG. 6.

Flowchart 700 begins at step 702 by obtaining a roll of the absorbent layer. In step 704, at least a length of the absorbent cupholder liner is unrolled; and in step 706, the barrier layer is applied to the unrolled length of the absorbent layer.

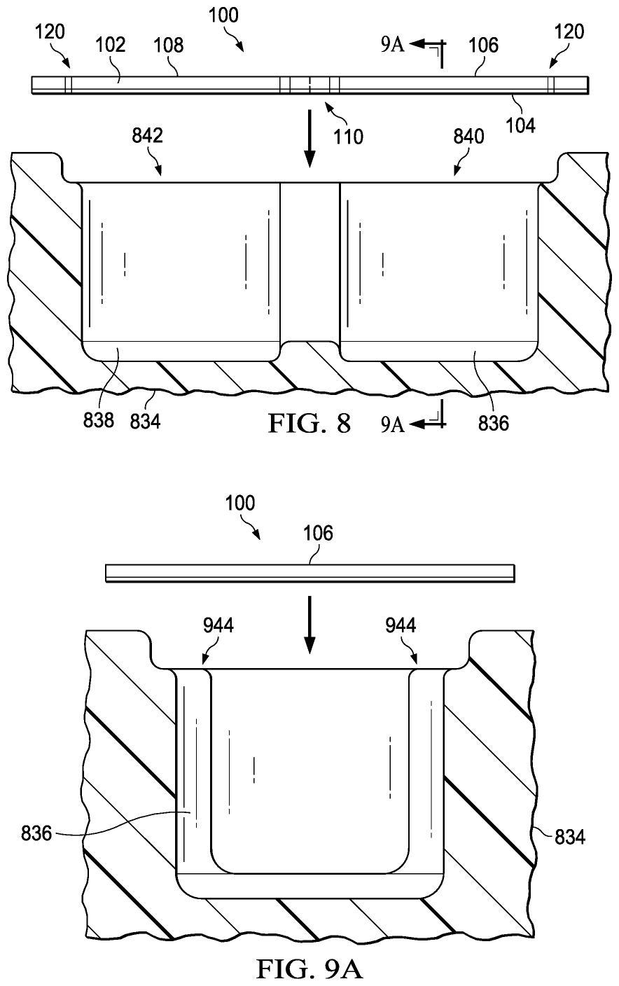

FIG. 8 is a cross section view from the side of an illustrative embodiment of the absorbent cupholder liner 100 positioned above a vehicle cupholder 842, ready for insertion. The first absorbent body 106 and the second absorbent body 108 can be oversized such that the circumference of each absorbent body 106, 108 is larger than the circumference of the insertion aperture 840, 842 and bottom of each of the vehicle receiving chambers 836, 838. Because the absorbent bodies 106, 108 are oversized, when inserted into their respective vehicle receiving chambers 836, 838, the edges of both absorbent bodies 106, 108 can engage the sides of each of the corresponding vehicle receiving chambers 836, 838, folds upward along the fold regions 120 and traveling up the sides of each of the vehicle receiving chambers 836, 838 as the absorbent cupholder liner 100 is inserted. Accordingly, the folded edges of the absorbent bodies, 106, 108 cover at least a portion of each of the sides near the bottom of their respective vehicle receiving chamber 836, 838.

The cupholder liner 100 in FIG. 8 is positioned above the vehicle cupholder 834 such that the narrow bridge 110 is roughly aligned to cover the gap between the vehicle receiving chambers 836, 838 of the vehicle cupholder 834. Then, the perforation 128 that traverses across the narrow bridge 110 can be centered directly between the two receiving chambers 836, 838, equidistant from both. However, the perforation 128 can have differing distances from each of the receiving chambers 836, 838 if it is preferred or circumstanced require. The cupholder liner 100 in FIG. 8 is disclosed to be oriented such that the barrier layer 104 is facing downward and the absorbent layer 102 is facing upward. However, the barrier layer 104 can be positioned facing upward, away from the vehicle receiving chambers 836, 838, meaning the absorbent 104 layer is facing downward and into the receiving chambers 836, 838.

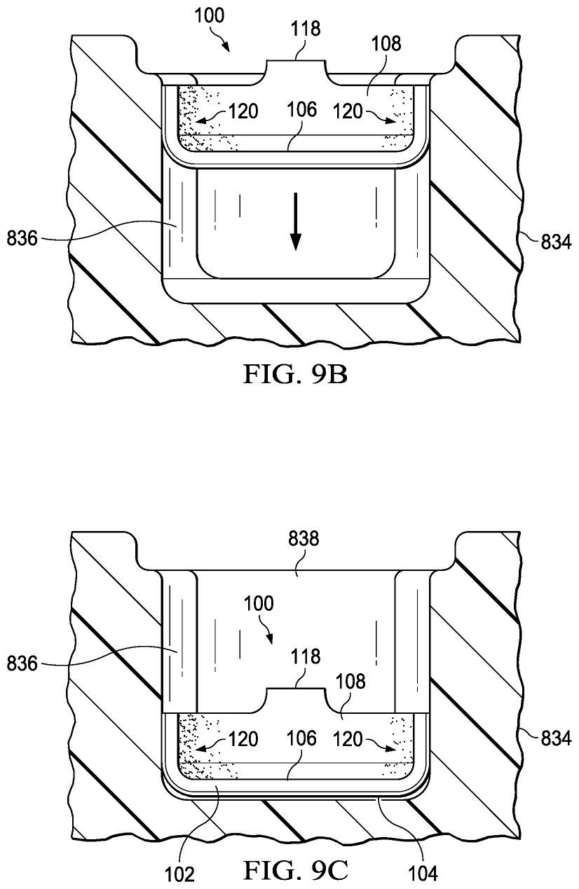

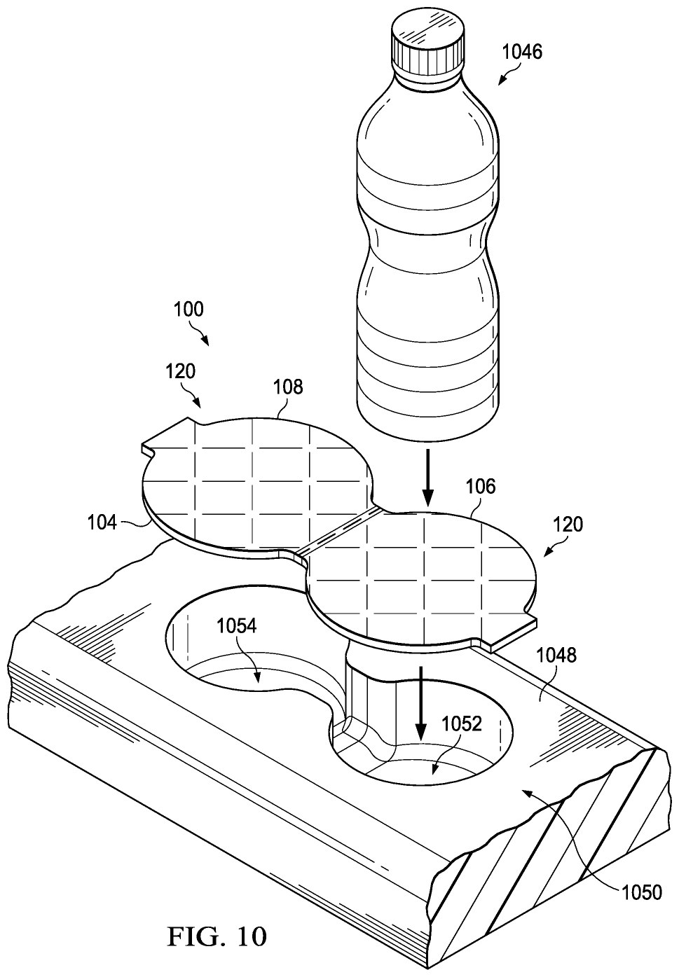

FIG. 9A is a cross section view from the front of an illustrative embodiment of the absorbent cupholder liner 100 positioned above a vehicle cupholder 834, ready for insertion. The first absorbent body 106 can be positioned above a vehicle receiving chamber 836 of the vehicle cupholder 834 such that the edges of the first absorbent body extend over the lip 944 of the vehicle receiving chamber 836.

FIG. 9B is a cross section view from the front of an illustrative embodiment of the absorbent cupholder liner 100 in the process of being inserted into a vehicle cupholder 834. Because the first absorbent body 106 and the second absorbent body 108 are oversized, the edges of the first absorbent body 106 and the second absorbent body 108 have folded upward along the fold region 120, conforming to the shape of the vehicle receiving chambers 836, 838. The folded edges of the absorbent bodies 106, 108 have begun to travel up the sides of the receiving chambers 836, 838. The second tab 118 which is affixed to the far side of the second absorbent body 108 has also folded upward along the fold region 120 and traveled up the side of the receiving chamber 838. By traveling up the side, the second pull tab 118 is positioned to allow for it to be gripped easily if need be.

FIG. 9C is a cross section view from the front of an illustrative embodiment of the absorbent cupholder liner 100 fully inserted into a vehicle cupholder 834. The absorbent layer 102 is facing upward, while the barrier layer 104 is primarily adjacent to the bottom of the vehicle receiving chambers 836, 838, facing predominantly downward. By folding along the fold region 120 and traveling up the side of the receiving chamber 838, the second pull tab 118 is positioned so that it can be easily gripped. The first pull tab (not shown) has also folded along the fold region 120 and traveled up the side of the receiving chamber 836, making the first pull tab easily accessible as well. Now that the absorbent cupholder liner 100 has been fully inserted into the vehicle cupholder 834, it is ready to receive a beverage and provide protection to the bottom of the receiving chambers 836, 838 from spillage.

FIG. 10 is a perspective environmental view of an illustrative embodiment of an absorbent cupholder liners 100 positioned for insertion into a vehicle cupholder 1048 with a water bottle 1046. One method of insertion of the absorbent cupholder liner 100 into a vehicle cupholder 1048 is by pushing downward on the first absorbent bodies 106 with the water bottle 1046. The absorbent cupholder liner 100 can be oversized compared to the bottom of the receiving chambers 1052, 1054, with the water bottle 1046 is positioned above the first absorbent body 106 which, in turn, is positioned above a vehicle cupholder 1048.

The method of insertion illustrated in FIG. 10 features the base of the bottle 1046 centered roughly in the middle of the first absorbent body 106. With the bottom of the water bottle, the user can push downward, pressing the bottom of the water bottle into the first absorbent body 106. When the edges of the absorbent cupholder liner 100 come in contact with the lip 1050 of the cupholder, the edges can fold along the fold region 120 around the base of the bottle 1046. As the bottle 1046 pushes the absorber cupholder liner 100 further into the receiving chambers 1052, the edges are automatically folded along the fold region 120 and travel up the sides of the receiving chamber 1052. Once the first absorbent cupholder liner 100 has been fully inserted, the method of insertion can be repeated on the second absorbent body 108. Alternatively, the second absorbent body 108 can be inserted first or both absorbent bodies 106, 108 can be inserted at the same time. After both absorbent bodies 106, 108 have engaged the bottom of their respective receiving chambers 1052, 1054 such that the barrier layer 104 protects the bottom of the receiving chambers 1052, 1054 and the edges have traveled up the sides around the bottom of the receiving chambers 1052, 1054, the insertion of the absorbent cupholder liner 100 has been completed.

While the method of insertion in FIG. 10 depicts the use of a water bottle to position the cupholder liner 100 into the vehicle cupholder 1048, the depicted method is illustrative and nonlimiting. In another embodiment, another form of container or vessel, or even the user's hands can be used to press the cupholder liner 100 into the vehicle cupholder 1048.

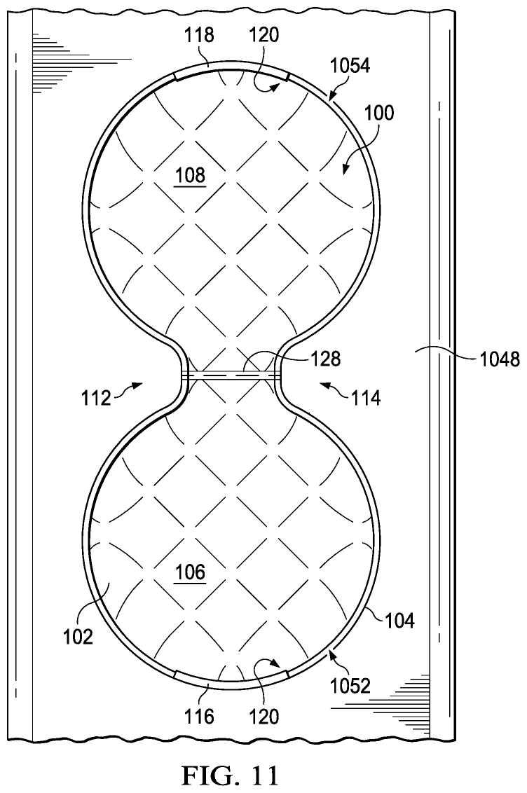

FIG. 11 is an environmental view from the top of an illustrative embodiment of the absorbent cupholder liner 100 fully inserted into a vehicle cupholder 1048. The absorbent cupholder liner 100 has been fully inserted into the cupholder 1048 with the first absorbent body 106 and second absorbent body 108 centered and inserted into receiving chambers 1052, 1054. Edges along the exterior of the opposing concavities 112, 114 and the first absorbent body 106 and second absorbent body 108 have folded along the fold region 120, traveling up the sides of the receiving chambers 1052, 1054 and the gap between the receiving chambers 1052, 1054. Traversing the distance between the opposing concavities 112, 114, the perforation 128 can be positioned to be in the center of the cupholder 1048. The first pull tab 116 and the second pull tab 118 can be pointed upward, away from the bottom of the receiving chambers 1052, 1054 on opposite sides of the cupholder liner 100 for easy gripping. Adjacent to the bottom of the receiving chambers 1052, 1054, the barrier layer 104 provides protection, while the absorbent layer 102 can be positioned facing away from the bottom of the receiving chambers 1052, 1054 to protect against spillage.

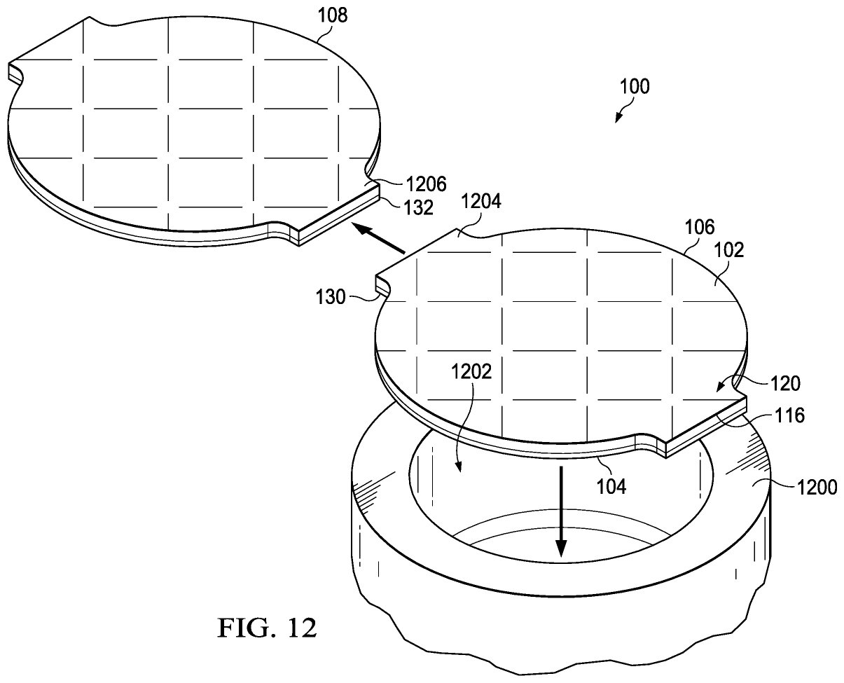

FIG. 12 is a perspective environmental view from the top of an illustrative embodiment of an absorbent cupholder liner 100 in which the first absorbent body 106 is detached from a second absorbent body 108 and positioned above a single chamber cupholder 1200, ready for insertion. Because the first absorbent body 106 has been separated from the second absorbent body 108 along the partition, the separated second absorbent body 108 functions separately and independent from the first absorbent body 106. While the first linear edge 130 and the second linear edge 132 previously helped form the narrow bridge that separated the two absorbent bodies 106, 108, after the first absorbent body 106 and second absorbent body 108 have been separated, the first linear edge 130 becomes part of a third pull tab 1204 and the second linear edge 132 becomes part of a fourth pull tab 1206.

Positioned above a receiving chamber 1202 of the single chamber cupholder 1200, the first absorbent body 106 is ready to be inserted. Because the first absorbent body 104 is oversized, the edges can fold along the fold region 120 and travel up the sides of the single receiving chamber 1202, facilitating the orientation of the first pull tab 116 and third pull tab 1204 so that they are both pointed upward, away from the bottom of the single chamber cupholder 1202 to allow for easy access. Once fully inserted, the barrier layer 104 can be facing downward, while the absorbent layer 102 can be facing upward. If preferred or if circumstances require, the absorbent layer 102 can be placed adjacent to the bottom of the single receiving chamber 1202 and the barrier layer 104 can be facing upward and away. While the first absorbent body 106 in FIG. 12 is formed by detaching the two absorbent bodies 106, 108 of an absorbent cupholder liner 100 along the perforation, a single first absorbent body 106 can also be purposefully formed during the manufacturing process without ever being attached to a second absorbent body 108.

Some embodiments of the absorbent cupholder liner may include printed or added self-promoting language on the barrier layer and/or the absorbent layer which can include information such as re-order information, web address, brand name, logo, phone number, discount offers or codes, or rebates, etc. In addition, some embodiments can include cosmetic designs, colors, patterns, images, etc. applied to or overtop of the absorption layer and/or the barrier layer to appeal esthetically to the consumer. In some instances, embodiments may be used to advertise for other companies by including printed or additional messages, logos, web addresses, phone numbers, colors, patterns, images, etc. to or overtop of the absorption layer and/or the barrier layer, but only when contracted directly with the legal operating entity and only under contract to be distributed exclusively to the said company for additional financial compensation purposes.

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. For example, in some embodiments, the cupholder liners can be formed as singular, generally disc-shaped absorbing body, with or without tabs, rather than the dual-absorbing body embodiments depicted in the figures above. Additionally, the number and configuration of the pull tabs can be modified as desired. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called filed. Further, a description of a technology as background information is not to be construed as an admission that certain technology is prior art to any embodiments) in this disclosure. Neither is the “Brief Summary” to be considered as a characterization of the embodiments(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

1. A cupholder liner comprising:
a first absorbing body formed from a first absorbent layer adhered to a first barrier layer;
a second absorbing body formed from a second absorbent layer adhered to a second barrier layer; and
a narrow bridge coupling the first absorbing body and the second absorbing body.

2. (canceled)

3. The cupholder liner of claim 1 further comprising:
a first pull tab extending outwardly from the first absorbing body; and
a second pull tab extending outwardly from the second absorbing body.

4. The cupholder liner of claim 1, wherein
the first absorbing body is substantially circular; and
the second absorbing body is substantially circular.

5. The cupholder liner of claim 4, wherein the first absorbing body and the second absorbing body are sized to be received into a cupholder so that at least some of the periphery of each of the first and second absorbing bodies engages the bottom of the cupholder and the sidewalls of the cupholder.

6. The cupholder liner of claim 4, wherein the first absorbing body and the second absorbing body are oversized compared to the cupholder so that, when the cupholder liner is inserted into the cupholder, at least some of the periphery of each of the first and second absorbing bodies engages the bottom of the cupholder and the sidewalls of the cupholder, folding along a fold region and traveling up at least some of the sidewalls of the cupholder.

7. The cupholder liner of claim 1, further comprising a fragrant compound.

8. The cupholder liner of claim 1, wherein the bridge further comprises a perforation that allows the cupholder liner to be separated into two identical pieces.

9. The cupholder liner of claim 1, wherein the absorbent layer is formed from a plurality of layers.

10. The cupholder liner of claim 1, wherein the absorbent layer is formed from at least one of paper, sponge, or cotton, and wherein the barrier layer is formed from at least one of nylon, polyester, vinyl, pleather, plastic, or vulcanized rubber.

11. A method for manufacturing cupholder liners, comprising:
applying a barrier layer to an absorbent layer to form a layered sheet; and
partitioning the layered sheet into a plurality of the cupholder liners, wherein each of the plurality of cupholder liners comprises at least one absorbing body.

12. The method of claim 11, wherein applying the barrier layer further comprises applying a rubber layer to the absorbent layer.

13. The method of claim 12, wherein applying the rubber layer further comprises spraying a liquid rubber solution onto the absorbent layer.

14. The method of claim 13 further comprising:
curing the rubber layer to form a vulcanized rubber layer.

15. The method of claim 14, wherein curing the rubber layer further comprises exposing the rubber layer to an external source of heat.

16. The method of claim 11, further comprising applying a fragrant compound to the cupholder liner.

17. The method of claim 11, wherein partitioning the layered sheet further comprises:
cutting the layered sheet with a press plate pressed onto the layered sheet.

18. The method of claim 11, wherein applying the barrier layer further comprises:
obtaining a roll of the absorbent layer;
unrolling at least a length of the absorbent layer; and
applying the barrier layer to the unrolled length of the absorbent layer.

19. The method of claim 11, wherein the at least absorbing body includes a first absorbing body connected to a second absorbing body by a narrow bridge, and wherein partitioning the layered sheet further comprises perforating each of the plurality of cupholder liners along the narrowed bridge.

20. The method of claim 11, wherein applying the barrier layer to the absorbent layer further comprises adhering the barrier layer to the absorbent layer.

21. The cupholder liner of claim 8, wherein the perforated bridge, when separated functions as a first pull tab extending from the torn linear edge of the first absorbing body and a second pull tab extending from the torn liner edge of the second absorbing body.
